(19) United States
(12) Patent Application Publication
(10) Pub. No.: US 2007/0138325 A1
(43) Pub. Date: Jun. 21, 2007

(54) Spraying and atomization device of a saline mixture

(75) Inventor: Pablo Rodriguez Fernandez, Burgos (ES)

Correspondence Address: DENNISON, SCHULTZ & MACDONALD, 1727 KING STREET, SUITE 105, ALEXANDRIA, VA, 22314, US

(73) Assignee: VYR- Valvuleria y Riegos por Aspersion, S.A.

(21) Appl. No.: 11/524,467

(22) Filed: Sep. 21, 2006

(30) Foreign Application Priority Data
Dec. 20, 2005 (ES) 200502762U

(51) Int. Cl. A62C 31/02

(52) U.S. Cl. 239/589; 239/600

(57) ABSTRACT

This invention relates to a spraying and atomization device of a saline mixture consisting of a minimum number of pieces integrated in a main head or base of those that are arranged underground in automatic centralized installations of electronic activity and control, comprising a prismatic body laterally reinforced by a group of ribs and a front fitting in the lower part thereof communicating through a vertical duct with an inner chamber where there is housed a support body and a spraying and diffuser nozzle, and in the latter there is a feed nozzle ending in a stepped neck where a fixing washer is assembled housed on the upper opening of said head-base and fixed by pressure on the upper neck of the support body and spraying and diffuser nozzle.

As indicated by the title, this invention relates to a nozzle assembly for the spraying or atomization of a saline mixture under pressure, more specifically a brine mixture particularly intended for preventing icing over or for melting it, which is scattered on highways either by hand, with mechanical means and more recently by spraying or atomizing it through automatic pressurized spray means through centralized electronically controlled networks, thereby obtaining more widespread, homogenous and stronger projection of the product.

The object of the invention consists of a scattering or diffusing body referring to a pressurized spraying or atomization nozzle formed mainly by a coaxial cylindrical body having mixture feed ducts and assembled in an intermediate body seated on an elastic base for its closing steps, which consists of the mixture outlet and projection ducts, and in turn it is contained in a spray base or head comprising radial fittings for the feed hose.

### BACKGROUND OF THE INVENTION

There are many devices used in the state of the art for the diffusion, sprinkling, irrigation, atomizing or spraying of water in particular, or liquid products and other products mixed with solids that are used for the pressurized projection in different abrasion functions for machining, cutting, tooling, or the like, and others intended for hewing, polishing or cleaning, as is the case of Spanish patent ES 2 110 971 T3 in relation to a “HIGH PRESSURE INJECTION NOZZLE” of Kawasaki Jukogyo Kabushiki Kaisha, having a radial fitting opening into an expansion chamber where a duct having a cylindrical projection having much less diameter originated in a cone-shaped mouth having acceleration and projection at progressive pressure begins. Spanish patent ES 0467266 describes a “SPRAY NOZZLE FOR IRRIGATING APPARATUS” de Rain Bird Sprinkler MFG. Corp., which is a cylindrical head having a side opening of arched angular projection with a shell striated with conducting ribs for the projection and dispersion of the liquid jet. Spanish patent 0423570 describing “A FLUID EMITTING DEVICE WITH FLOW RESTRICTION” of Donald Olaf OLSON and Spanish patent ES 0413726 describing “AN AERATOR SPRAY DEVICE”, of MASCO Corp., have other mechanical versions that have been simplified and improved by the idea of the invention set forth.

### DESCRIPTION OF THE INVENTION

The invention is formed by an atomization or spraying head or base for a saline mixture of water and salt in brine state that is used to spread or scatter it on frosted or frozen surfaces or the like, or on surfaces with the risk that they may frost or freeze for the purpose of preventing these situations from occurring; therefore said head is made up of an external body strengthened by external ribs and comprises radial fittings for feeding said mixture having great diameter or having a diameter greater than that of the outlet or spray duct for generating the pressurized projection of said mixture.

The base or head in question has an internal chamber communicated with the fitting duct and in which it is mainly housed in a support body adjusted in said chamber in a leak-tight manner and closed by an elastic O-ring located at the base of said support body against a re-entrant angle seating, the edge of which is seated against the projecting ridge of the base of the cylindrical body of the feed nozzle, sealing the fitting between said O-ring and the lower support of the chamber.

Another essential detail is that said support body has an internal configuration of converging stepped diameters to end in a nozzle having radial upwardly inclined or fan projected ducts (two opposite radial ducts) for projecting the mixture under pressure, and in which said ducts have a profile that is less than that of the feed duct of the axial nozzle to provide greater pressure at its thin outlet openings.

According to the invention, said nozzle has an axial saline mixture outlet that starts in a short sector connected to the inlet fitting; said duct is coaxially extended in a main section of less diameter than the previous one, and it is an acceleration section ending in the projection nozzle inside the support body, coinciding with the projection ducts that the latter has at its upper end which also consists of a stepped outer seating where a ring-shaped fixing crown is assembled which tightly fits in an upper cavity of the head-base, holding the support body and the nozzle inside the chamber.

Another detail of the invention is that the ring-shaped crown has an outer surface of planar configuration so as to facilitate the projection of the outlet ducts for spraying in a certain direction, and a lower cone-shaped base resting against the central base of the support body, adjusting it against the O-ring seal by means of pressure exerted in two cylindrical blind orifices provided on the surface of the washer. This pressure is generated by placing said washer in side recesses of the upper neck of the support body and turning it, exerting pressure against the general diameter of said neck. The assembly is built with a minimum number of pieces and with the consistency required to withstand the straining due to the pressure of a mixture of this nature.

A better idea of the features of the invention shall be provided below in reference to the sheet of drawings attached to this specification, in which the preferred details of the invention are shown schematically and only by way of example.

### DESCRIPTION OF THE DRAWINGS

FIG. 1 shows an exploded perspective view of the sprayer-atomizer head assembly (1) seen in front foreshortened plan view, with the feed fitting (3).

FIG. 2 shows a perspective view of the same head assembly (1) assembled or mounted, showing the diffuser nozzle (7) and the diffuser ring (9).

FIG. 3 shows a perspective view similar to the previous one, the assembled or mounted head (1) being vertically sectioned in transverse direction, showing the fitting (3), the support body (15) of the body of the nozzle (6) and the O-ring (5).

FIG. 4 shows an elevational view of the assembly (1) vertically sectioned by a symmetrical plane.

FIG. 5 shows an enlarged detail of the previous Figure and also sectioned by a symmetrical plane.

FIG. 6 shows an elevational view from one end of the base body (1).

FIG. 7 shows a longitudinally sectioned view of the body (1) of FIG. 6.

FIG. 8 shows an upper plan view of the body (1) of FIG. 6.

FIG. 9 shows a partial sectional view of the anchoring members of the body (1).

FIG. 10 shows an elevational view of the support body (15) of the nozzle (6).

FIG. 11 shows a symmetrically cut view diametrically of the support body (15) of FIG. 10.

FIG. 12 shows an upper plan view of the support body (15) of FIG. 11.

FIG. 13 shows a perspective view of the support body (15).

FIG. 14 shows an elevational view of the ring-shaped nut (8).

FIG. 15 shows an upper plan view of the washer (8) of FIG. 14.

FIG. 16 shows a vertical view of the washer (8) of Figure (15) symmetrically and diametrically cut.

FIG. 17 shows a perspective view of the washer (8) of FIG. 16.

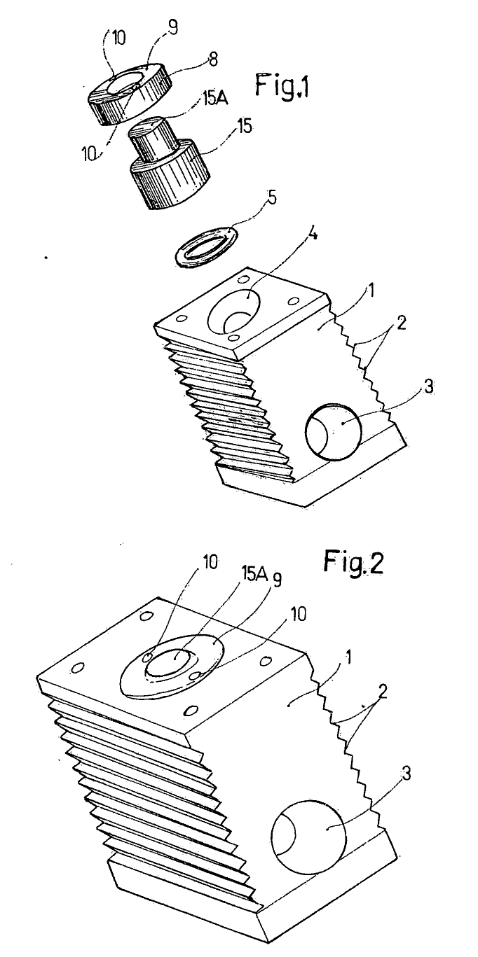

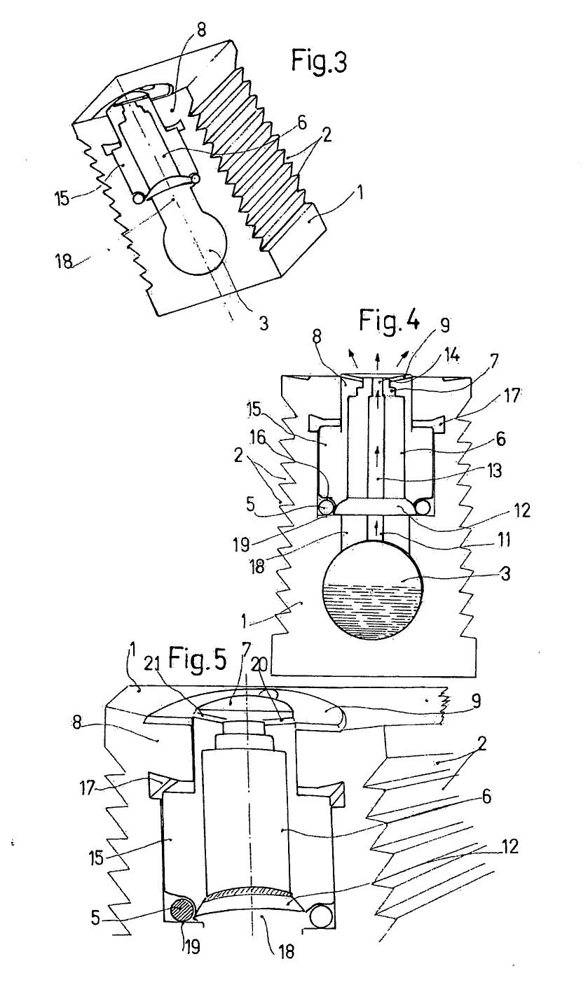

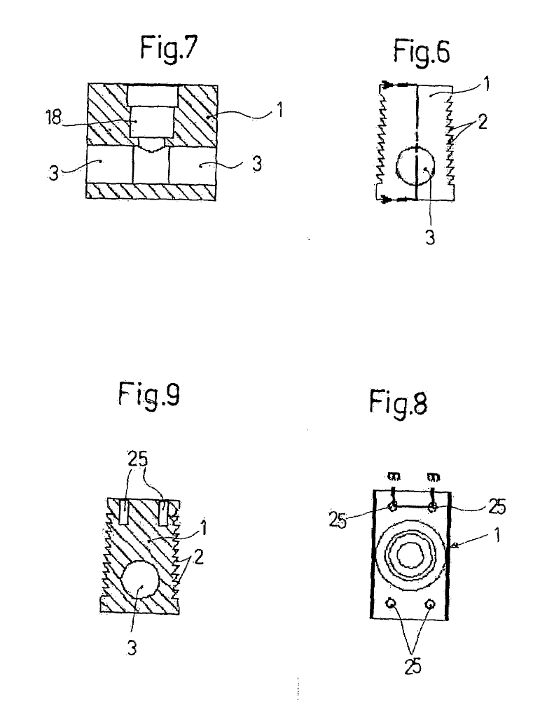

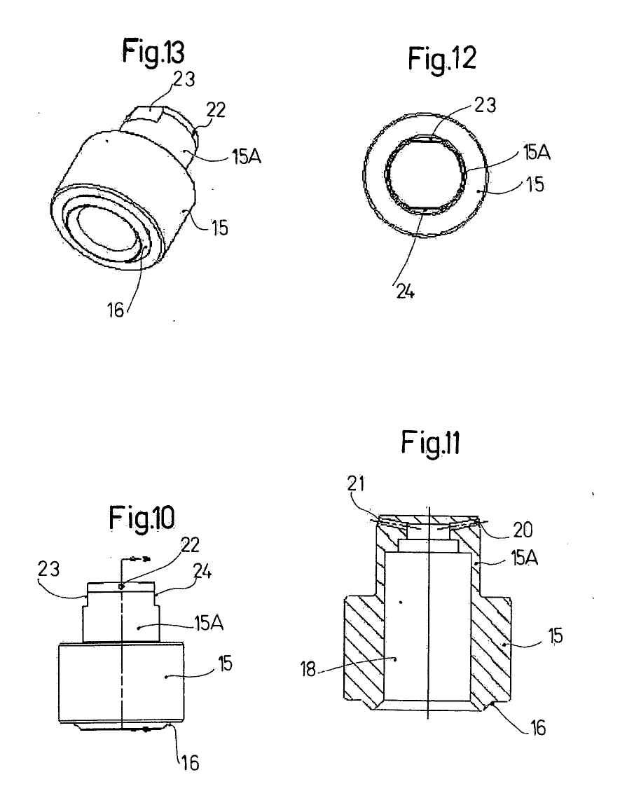

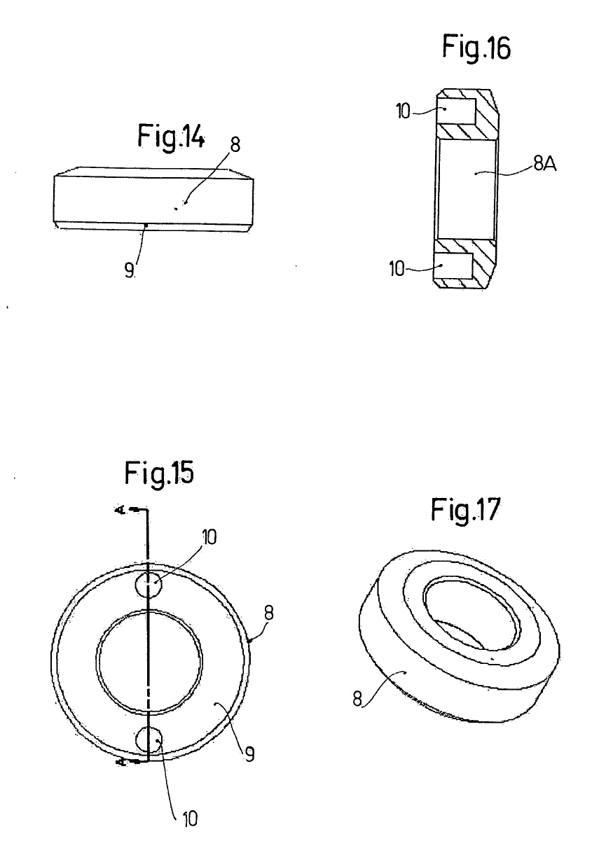

### PREFERRED EMBODIMENT OF THE INVENTION

A preferred embodiment of the invention is justified by the object depicted in the drawings which, as can be seen, consists of an assembly manufactured in plastic materials, preferably PVC, which are arranged in centralized facilities with automatic activity and electronic control function, arranged in underground assemblies in roads (freeways, highways, roads) on which the diffusing, atomization or spraying action or the like, of said nozzles is to be applied, such nozzles according to the preferred embodiment comprise a had with a prismatic rectangular shape (1) with sides reinforced with successive, transverse angular ribs (2), an axial housing open at the top (4), and a front feed fitting (3) in the lower part of said head having a vertical projection (18) and an inner chamber (17) housing a support body with a projection nozzle (15), the body of the feed nozzle (6) being assembled therein.

The mentioned chamber (17) forms, at the meeting point with the vertical access (18), a support (19) for the cone-shaped base (12) of the body of the nozzle (6) and houses in its contour an elastic O-ring (5) for the seating of the nozzle-support body (15) provided with a seating having a concave angle (16) on the bottom and at the top consists of respective radial and upwardly inclined atomization ducts (20-21) (FIG. 11) and thin outlet openings (22) (FIG. 10), above the surface (9) of the fixing washer (8).

The body of the nozzle (6) has a coaxial outlet duct completely traversing it and starting in an inlet area (11) in communication with the saline mixture feed fitting (3) and having much less diameter that the latter; it continues in a main section (13) having slightly less diameter than the former, which is an acceleration duct, ending in an outlet nozzle (14) having much less diameter to assure the pressurized projection of the mixture expelled through the atomizing ducts (20-21) having less diameter than the latter.

The upper part of the body of the nozzle (6) has a seating having stepped diameters (7) where the sealing washer (8) of the support body (15) having a planar surface (9) for the diffusion of the mixture, is assembled; it also has several cylindrical blind holes (10) for regulating the closing or fixing pressure of said washer (8) (by means of a tool) against the upper neck (15A) (FIGS. 10-12) of the support neck (15) having tangent side recesses (23-24) (FIG. 10 and 12) so as to facilitate the assembly of the washer (8), which has an inner diameter (8A) adjusted to said recesses and thus able to press against the general diameter of the neck (15A).

Finally, the surface of the head-base (1) has other cylindrical blind holes (25) (FIGS. 8 and 9), one in each corner, for complementary functions.

With a minimum number of pieces, the assembly assures the effective operation of the pressurized atomization or spraying of a known saline mixture, such as brine.

Having sufficiently described the nature of the invention, it is hereby stated for all intents and purposes that such invention is not limited to the exact details of this explanation, but on the contrary, those modifications considered appropriate will be introduced provided that they do not alter the essential features thereof which are claimed below.

What is claimed is:

1. A spraying and atomization device of a saline mixture, consisting of an assembly manufactured in plastic PVC materials or the like, with a minimum of pieces integrated in a main head or base that are arranged underground in automatic centralized installations of electronic activity and control, characterized in that it comprises a prismatic body (1) laterally reinforced by a group of ribs (2) and a front fitting (3) in the lower part communicating through a vertical duct (18) with an inner chamber where there is housed a support body and a spraying and diffuser nozzle (15), and in the latter there is a feed nozzle (6) ending in a stepped neck (7) where a fixing washer (8) is assembled housed on the upper opening (4) of said head-base (1) and fixed on the upper neck (15A) of the support body and spraying and diffusing nozzle (15).

2. A spraying and atomization device of a saline mixture according to claim 1, wherein the inner chamber (17) of the head (1) is characterized in that in the union of said chamber (17) with feed duct (18), it has a ring-shaped support (19) where the base of a lower cone-shaped rib (12) of the feed nozzle (6) is seated and where there is housed an elastic O-ring (5) where, in turn, the support body and diffusing and spraying nozzle (15) are seated, which for that purpose has a circular concave seating (16).

3. A spraying and atomization device of a saline mixture according to claim 1, wherein the feed nozzle (6) has an integral coaxial duct that is characterized in that it starts in a short inlet area (11) communicated with the inlet fitting (3), with much less diameter than the latter, and it projects into a main duct (13), having somewhat less diameter than the latter, or an acceleration section, ending in another section (14) of less profile for the pressurized projection of the mixture exiting through the diffusing and spraying nozzle (1).

4. A spraying and atomization device of a saline mixture according to claim 1, wherein the support body and diffusing and spraying nozzle (15) is characterized in that on the upper end its has a neck (15A) with thin radial, and upwardly inclined projection ducts (20-21) and thin outlet openings (22).

5. A spraying and atomization device of a saline mixture according to claim 1, wherein said neck (15A) on the outside is characterized in that it laterally has tangent opposite recesses (23-24) provided for the assembly and tightening of the fixing washer (8) having an inner diameter that is adjusted to said recesses (23-24) in order to exert pressure against the outer profile of said neck (15A).

6. A spraying and atomization device of a saline mixture according to claim 1, wherein the washer is characterized in that it is a ring-shaped piece (8) assembled on the neck (15A) of the support body and diffusing and spraying nozzle (15) and has a planar outer surface (9) for diffusing the mixture and, at opposite U Am points, blind boreholes (10) for regulating the tightening of said washer (8) by pressure.

7. A spraying and atomization device of a saline mixture according to claim 1, wherein the head-base (1) is characterized in that it has blind perforations (25) for the anchoring functions thereof on the surface in each of its corners.
